(19) United States
(12) Patent Application Publication
(10) Pub. No.: US 2016/0180280 A1
(43) Pub. Date: Jun. 23, 2016

(54) ENTERPRISE RESOURCE MANAGEMENT ABSENCE REQUESTS IN HOURS AND MINUTES

(71) Applicants: Ralf Philipp, Altlussheim (DE); Jennifer Berg, Plankstadt (DE); Tobias Behnke, Mannheim (DE); Rehmatullah Alias Adil, Walldorf (DE); Christian Kirschnick, Leimen (DE); Christian Ortmann, Karlsdorf-Neuthard (DE)

(72) Inventors: Ralf Philipp, Altlussheim (DE); Jennifer Berg, Plankstadt (DE); Tobias Behnke, Mannheim (DE); Rehmatullah Alias Adil, Walldorf (DE); Christian Kirschnick, Leimen (DE); Christian Ortmann, Karlsdorf-Neuthard (DE)

(21) Appl. No.: 14/579,967

(22) Filed: Dec. 22, 2014

(51) Int. Cl. G06Q 10/06; G06Q 10/10; G06F 3/0484

(52) U.S. Cl. CPC G06Q 10/063116; G06F 3/04847; G06Q 10/1091

(57) ABSTRACT

In one aspect, there is a method. The method receiving an absence type and a balance of time for the absence type. The balance of time may be expressed in a days format, an hours format, and/or a minutes format. A display format for the balance of time may be selected at a user interface of the remote node. The remote node may receive metadata enabling a presentation of the balance of time in the display format. The method may include converting the balance of time to the display format, receiving a request for a absence corresponding to the absence type including an absence duration, converting the absence duration into the at least one format, sending the request for the absence, and/or receiving a response to the request.

### FIELD

The subject matter described herein relates to scheduling time in an enterprise resource planning system.

### BACKGROUND

Businesses rely on business enterprise resource planning (“ERP”) systems, solutions, programs, and other software to assist them in performing various tasks. The day-to-day operations of a business may include a multitude of tasks such as purchasing, sales, payroll, accounting, timekeeping, benefits administration, security, maintenance, and various other tasks that businesses need to perform. The ERP systems, solutions, and other software that may perform the tasks may come from different vendors and/or designed using different computing platforms (e.g., programming languages, operating environments, etc.).

Employees of a business may use various mobile devices to conduct some or their business activities. For example, time that an employee is absent from the job may be managed by an ERP system using mobile devices. The mobile devices may run one or more applications to interface to an absence management module in the ERP system.

### SUMMARY

In one aspect, there is a method. The method may include receiving, by a remote node, an absence type and a balance of time for the absence type. The balance of time may be expressed in a first format including at least one of a days format, an hours format, and/or a minutes format. The method may further include selecting, at a user interface of the remote node, a display format for the balance of time. The remote node may receive metadata enabling a presentation of the balance of time in the selected display format. The method may include converting the balance of time to the selected display format. The method may further include receiving, at the user interface of the remote node, a request for an absence corresponding to the absence type including an absence duration formatted in accordance with the selected display format. The method may include converting, by the remote node, the absence duration into the at least one format to provide comparability between selected display format and the first format. The method may include sending, by the remote node, the request for the absence including the absence type and converted absence duration. The method may include receiving a response to the request. The response may include an indication of whether the request for the absence has been granted. The indication may be determined at least by a validation that the balance of time is equal to or greater than the absence duration.

In some variations, one or more of the features disclosed herein including the following features can optionally be included in any feasible combination. The balance of time may include the minutes format and the display format may include the hours and minutes format. The minutes format may include a decimal quantity of minutes, and the hours and minutes format may include a decimal quantity of hours and a decimal quantity of minutes less than sixty. An amount of time in the hours format may be equivalent to the amount of time in the days format. The amount of time in the hours format may be equivalent to the amount of time in the days format. The amount of time in the minutes format may be equivalent to a number of whole minutes and a decimal fraction of a minute. The decimal fraction of the minute may be stored in a second format to provide accrual of time in the absence type. The first format may include the minutes format with the decimal fraction of the minute truncated or rounded down. The remote node may be one or more of a smartphone, a cell phone, a laptop computer, a tablet computer, a notebook computer, or a netbook. The absence type may include a vacation time, a sick time, a maternity leave, an educational leave, a personal time off, a paid leave, an unpaid leave, a marriage leave, or a bereavement leave. The hours format may include whole hours and one to ten decimal places. The days format may include whole days and one to ten decimal places. The minutes format may include whole minutes and one to ten decimal places.

### DESCRIPTION OF DRAWINGS

In the drawings,

FIG. 1 depicts an absence management module in an enterprise resource planning system including a mobile device and a web based user interface, in accordance with some implementations;

FIG. 2A depicts a screenshot from an employer's configuration of an absence type in an absence management module of an enterprise resource planning system, in accordance with some implementations;

FIG. 2B depicts a screenshot from an employee absence request form to an absence management module of an enterprise resource planning system, in accordance with some implementations;

FIG. 3 depicts a message exchange diagram between a mobile device and an application controller to create a new absence for an employee, in accordance with some implementations;

FIG. 4 depicts a message exchange diagram between a mobile device and an application controller to modify an absence for an employee, in accordance with some implementations; and

FIG. 5 depicts an apparatus, in accordance with some implementations.

Like labels are used to refer to the same or similar items in the drawings.

### DETAILED DESCRIPTION

An employee may be eligible for different types of absences such as vacation time, sick leave, maternity leave, educational leave or sabbatical, personal time off, marriage leave, bereavement leave, and other types of paid and/or unpaid absences. The balances of the different types of absence time may be maintained in a database in a decimal hours format, for example 6.14 hours. In some implementations, instead of requesting an absence in decimal hours format, an employee may request absence time in an hours and minutes format while the database maintains the balances of accrued absence time in a decimal hours format. When an employer configures an absence management module to allow employees to request absences in an hours and minutes format, the absence management module may convert an available quantity of hours stored in the database to an hours and minutes format. The transformation may round down the number of available minutes to ensure that the employee does not request an absence for longer than has been accrued. An employee may request an absence using a mobile device such as a smart phone, tablet computer, or the like. The request may be sent over a network such as a wired or wireless network, or the internet, to an absence management module of an ERP system. The ERP system, after receiving the employee's absence request, may respond by approving the request or denying the request, and then sending the decision to the user's mobile device to be displayed to the user. In some implementations, the absence request may trigger a workflow to a responsible party for decision about whether to approve or deny the request. In some implementations, the ERP system may automatically approve all requests for absences where sufficient time has been accrued.

The subject matter disclosed herein may have the technical effect of improving the portability of ERP system absence data between modules in the system. For example, a module representing absence times in hours and minutes may share or exchange information with other modules that represent absence data in hours and minutes. The subject matter disclosed herein may have the technical effect of decoupling the format of hours data at a user interface display from the absence information stored in an ERP system. For example, the ERP system may store absence information in decimal hours format and the user interface may display absence information in hours and minutes format or another format.

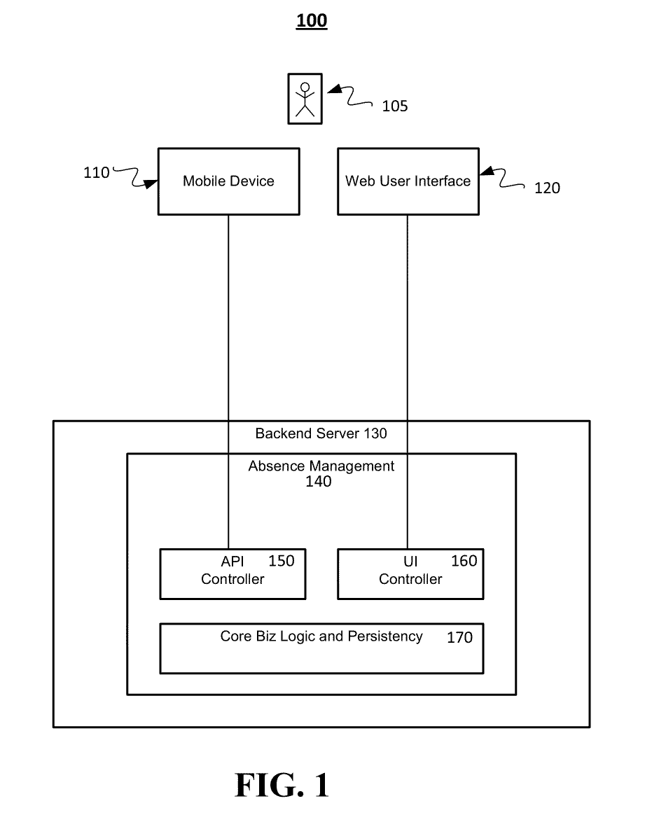

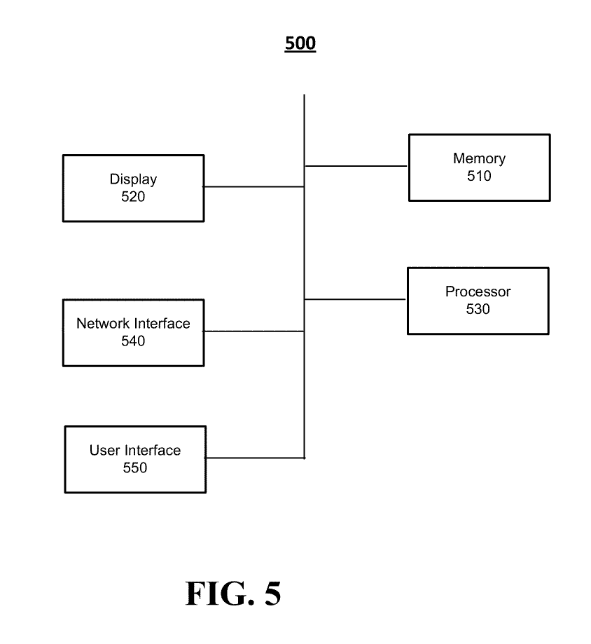

FIG. 1 depicts an absence management module, a mobile device, and a web based user interface in an enterprise resource planning system. An application running on a mobile device 110 or a web based interface 120 may send a request for an absence to an enterprise resource planning backend server 130. The backend server 130 may include absence management module 140 to respond to the absence request and provide absence balance information to mobile device 110. Mobile device 110 and/or backend server 130 may include a computing apparatus such as the apparatus shown in FIG. 5.

An application running on mobile device 110 may communicate with ERP backend server 130. The application may be downloaded and installed on a mobile device consistent with FIG. 5. The application may be available from various vendors who may sell their business solutions and/or applications for mobile devices via the Internet, third party vendors, and/or may be pre-installed on users' mobile devices.

Mobile device 110 may connect to ERP backend server 130 through a wired or wireless network connection and/or through the Internet. Mobile device 110 may also connect through another mobile of fixed device (not shown in FIG. 1) to ERP backend server 130. Mobile device 110 may include cellular telephones, portable computers, laptops, smartphones, netbooks, tablets, and/or any other mobile devices.

In some implementations, the application running on mobile device 110 may include an application programming interface (API) that may include a set of routines, protocols, and tools to exchange information, requests, and responses with backend server 130. The API may include operations, inputs, outputs, and underlying types for the communication with backend server 130. The API may include functionality that is independent of any particular implementation allowing for different software languages to be used to implement the application to communicate using the API. Some mobile devices may include small screens that may be limited in the amount of information that can be displayed because of their small size. Some mobile devices may also have limited user input due to their size (e.g., no keyboard). Because of the limited screen size and/or limited user input, the absence management features available at mobile device 110 may be limited compared to an interface to a larger and more capable device supporting a full set of features.

Web user interface 120 may connect to ERP backend server 130 through a wired or wireless network connection or through the internet. Web user interface 120 running on a computer may also connect through another computer or mobile device (not shown in FIG. 1) to ERP backend server 130. Web user interface 120 may include a web page or web interface accessed through a network connection and/or the Internet. The web user interface may run on a web browser. The browser may run on a fixed or mobile computing device such as a desktop computer, laptop computer, tablet computer, smartphone, netbook, notebook computer, or any other type of standard or proprietary computing device.

In some implementations, the web user interface 120 may connect to a user interface controller 160. User interface controller 160 may provide the same API interface as API controller 150 or may provide an interface with more or different information and/or controls including requests and responses. Web interface 120 may be used on computing devices with larger screens than mobile devices and that may have more user input capability (e.g., keyboard and mouse) than a mobile device. Web interface 120 may display more information due to the larger screen size and may provide for more extensive user input.

API controller 150 and user interface controller 160 may be included in absence management module 140 as part of backend server 130. API controller 150 may receive absence requests sent to the API controller according to the API format and protocol and respond to the requests according to the API format and protocol. User interface controller 160 may receive absence requests sent to the UI controller according to the UI format and protocol and respond to the requests according to the UI format and protocol. Backend server 130 may include other modules in addition to absence module 140 such as modules for payroll, sales, timekeeping, accounts payable, accounts receivable, and so on. Timekeeping may include time recording, attendance management, and/or clocking-in/clocking-out.

The absence management module 140 may store employer and employee names, store absence accounts and absence balances, receive requests for absences, and respond to the requests. For example, an employee may be eligible for different types of absences that may include: vacation time, sick leave, maternity leave, educational leave or sabbatical, personal time off, marriage leave, bereavement leave, and other types of paid and/or unpaid absences. The balances of the different types of absence time may be maintained in one or more absence accounts associated with the employer and the employee. The balances may be stored in the database as decimal hours, for example 6.14 hours. For example, an employer may set up an absence management module 140 for an employee with time accounts including educational leave, bereavement, and maternity leave and a combined account for sick leave and vacation. Time taken for bereavement may be subtracted from the employee's bereavement account and time taken as sick leave or vacation may be subtracted to the combined sick leave and vacation account. In some implementations, instead of a using decimal hours format, employees may request absence time in an hours and minutes format.

A database of employees may include the names of employees and corresponding to each employee the types of absences each employee is eligible to take and a corresponding quantity of hours that the employee is eligible to take for each type of absence. An employee or user, may be eligible for one or more type of absences. For each of the types of absences the employee is eligible to take, the employer may configure the format of the quantity of hours and how the quantity of hours may be presented to the employee in a user interface. In some implementations, the quantities of hours corresponding to some types of absences may be stored in a decimal hours format, for example 13.12 hours. In some implementations, an employer may select to display the quantity hours for one or more types of absences in an hours and minutes format, for example 7:18 (seven hours and 18 minutes). An employer may select to allow a request for one or more types of absences to be made in an hours and minutes format. The absence hours account for an employee may be maintained in a decimal hours format while the display and/or request to take absence time may be displayed in an hours and minutes format. An employer may select to display and/or allow scheduling of absences of some types to be made in a decimal hours format and/or in a days format, for example 2 days.

To illustrate, employee George Jetson, may be eligible for vacation time, sick leave, and bereavement leave. His employer, Spacely's Sprockets, may have configured an ERP absence module to allow for vacation time to be reserved in hours and minutes, sick leave to be reserved in decimal hours, and bereavement to be reserved in days. In this example, George's available vacation time may be transformed from a decimal hours format to an hours and minutes format. The transformation may round down fractions of a minute to ensure that the user interface on George's mobile device displays an available vacation time in hours and minutes that does not exceed his available vacation time in decimal hours at the ERP absence module. Using a web-based or mobile user interface, George may request vacation time up to his available time (when only accrued vacation time is allowed) in hours and minutes. George's hours and minutes vacation request may be converted into a decimal hours reservation in the ERP system. George may request sick leave in a decimal hours format, for example 4.1 hours, and bereavement in days, for example 2 days. Available sick leave and bereavement may be stored in the database in a decimal hours format. When George has less than the hours equivalent of a day of bereavement, the user interface may determine that the insufficient time causes his request to be denied.

In some implementations, the user interface display and/or request time format may be selected by the user, so long as the employer has allowed the format to be selected by the employee. For example, Spacely's Sprockets may allow George to request vacation in a decimal hours format, a hours and minutes format, or a days format. George may select on his mobile device to view and request vacation in any of these formats. In some example embodiments, a human resources administrator may access a user interface which may display George's requested absence time in a decimal hours format and/or in an hours and minutes format. The human resources administrator may approve, deny, conditionally approve, request more information from George, or take another action in response to George's absence request. In some example embodiments, the human resources administrator may initiate one or more requests that may be sent to George.

Backend server 130 may include core business logic and persistency 170 to perform some business activities and store and maintain various databases required by the ERP system including the above-noted absence database. Core business logic and persistency 170 may include databases for one or many businesses and may provide business ERP services to many businesses. In some implementations, some businesses may share an absence management system 140 and another business may have an independent absence management system (not shown in FIG. 1) including another core business logic and persistency (not shown in FIG. 1).

Providing absence times in hours and minutes may improve interoperability with other ERP systems or other systems that utilize hours and minutes formatted absence and/or time information. For example, some other systems may communicate using hours and minutes time formatted data. Hours and minutes formatted time may improve usability of hours information by users because users may be more comfortable or familiar with hours and minutes rather that decimal hours with fractional digits. In some example embodiments, hours and minutes may improve readability of absence time because, for example, 8:20 (eight hours and twenty minutes) may be displayed rather than displaying 8.333333333 hours. In some example embodiments, hours and minutes formatted data may improve system robustness because calculation of fractional digits may be done in the backend and may reduce the likelihood of time data inconsistencies and/or transmission errors.

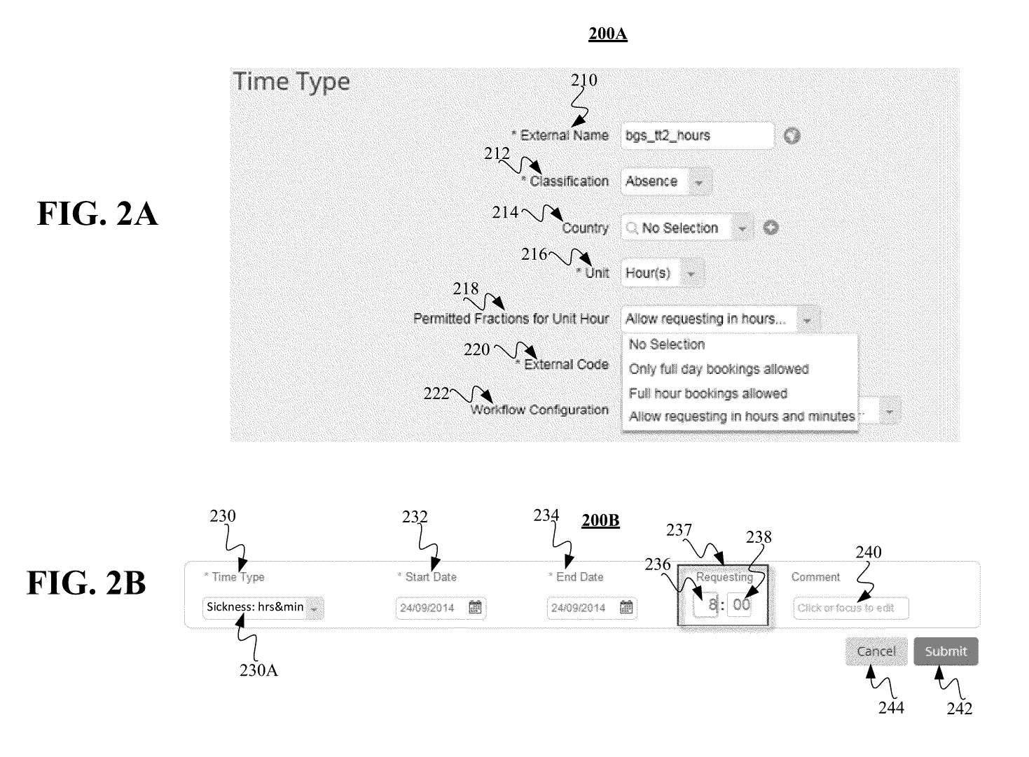

FIG. 2A depicts a screenshot 200A from the employer's configuration of a absence type in an absence management module of an ERP system. A absence type configuration allows the employer to select via a user interface including a display, a family of parameters defining the absence type. The absence type may include an external name 210, a classification 212, a country 214, units 216 for the classification, permitted fractions for the unit, an external code 220, and a workflow configuration 222. FIG. 2A also refers to FIG. 1.

An external name 210 may include a business name. The business name may be dependent on a language, for example German. External code 220 may include an identifier that may be language independent. For example, external codes may include vacation, or holiday, or other codes. Workflow configuration 222 may identify a type of routing for an absence request. For example, a workflow routing may include automatic approval of the request, no routing required, or a multi-step approval for absence requests. Classification 212 may indicate the parameter that the absence type may be applied to. For example, a drop-down menu may be available in the configuration screen to select a classification from a list. For example, a classification may be “absence” and may include employee absences from work. The classification drop-down menu 212 may include absence account names such as “sickness,” “vacation,” “maternity leave,” and so on to allow the absence type for a particular account name to be configured or by selecting “absence” the absence types for all account names that are absences may be configured. A country to apply the absence type to may be selected from a list in a drop-down menu. For example, “Germany”, “France”, or “United States” may be selected to apply the absence type. A unit 216 for the absence type may be selected from a list in a drop-down menu. For example, “hours” may be selected from a drop-down menu. In some implementations, “hours” may be the only available units for a absence type.

In some implementations, after configuring the unit 216 a drop-down menu for permitted fractions of an hour 218 may become active. The drop-down menu may have options to allow requesting hours in formats including “no selection,” “only full day bookings allowed,” “full hour bookings allowed,” and/or “allow requesting in hours and minutes.” The drop-down menu may also include “decimal hours” format for specifying time in hours plus decimal digits such as tenths of hours and hundredths of hours (not shown in FIG. 2A) or in an hours, minutes, and seconds format. Other hour formats may also be selectable in the drop-down menu for fractions for unit hour. In some implementations, more than one of the permitted fractions 218 may be selected. For example, the absence type may be selected to allow for “decimal hours” and “hours and minutes” or any other combination of two or more of the options in the permitted fractions 218. Selected options may be marked with a check mark next to the option or any other visual marking to indicate the option has been selected. To select multiple options, the drop-down menu may be opened multiple times to select an option each time.

In some implementations, the absence type configuration may be accessed by an employer at the location of the backend server 130 hardware. The employer may access the absence type configuration using a mobile device connected via the internet or network connection to the backend server 130 or via a device that is not mobile. In some implementations, when the employer selects multiple absence type formats that the employee may use, the employee may access the absence type configuration for his/her accounts to select his/her preferred time formatting for absences.

FIG. 2B depicts a screenshot 200B from an employee absence request form to an absence management module of an ERP system. The absence request may include a absence type 230, a start date 232, an end date 234, and a quantity of time 237 including hours box 236 and minutes box 238, and a comment 240. The absence request may be submitted by selecting or clicking on “submit” 242 or may be cancelled by selecting or clicking on “cancel” at 244. FIG. 2B also refers to FIGS. 1 and 2A.

At absence type 230, a selection may be made from a list in drop-down menu 230A that may combine a classification such as classification 212 and a permitted fraction for unit hours 216. For example, one of the available selections may include “sickness:hrs&min” corresponding to the employee's sick time selected in hours and minutes. Other selections may be available including other combinations of a type of absence (or absence account) and a permitted fraction. For example, selections may be available for sick time selected in decimal hours may be represented as “sickness:dec.hrs,” sick time in hours only may be represented as “sickness:hrs,” and sick time in full days may be represented as “sickness:days.” Other representations may also be used. One of the quantities of time in the list may include the maximum number of sick hours available. For example, if the employee has 3.5 hours available of sick time, the maximum value in the list may be 3.5 hours. Other types of absences determined by the employer such as vacation time, maternity leave, educational leave or sabbatical, personal time off, marriage leave, bereavement leave, and other types of paid and/or unpaid absences, may be combined with the fractions 218 enabled by the employer and presented at 230.

When an absence type 230 is selected at 230A including an hours fraction, a selection menu 237 corresponding to the included hours fraction is displayed. For example, when “sickness:hrs&min” is selected at 230A, a selection menu 237 is displayed including box 236 to enter or select a quantity of hours and box 238 to select or enter a quantity of minutes. In some implementations, the employee may enter a quantity of hours and minutes from a keyboard and/or select using a drop down menu allowing a selection of hours and minutes from a list or via selection “wheels” to select the quantity of time. When a an absence type 230 is selected in a decimal hours format box 236 may correspond to hours and box 238 may correspond to fractional decimal hours such as 0.1, 0.2, 0.3, and so on. Other sets of fractional hours may also be presented at boxes 236 and/or 238. One of the quantities of time in the list may include the maximum number of hours available. For example, if the employee has 3 hours and 30 minutes available of sick time, the maximum value in the list may be 3 hours and 30 minutes. An hours wheel may allow for selection of a quantity of hours by enabling a wheel to scroll through quantities of hours in the selection box 236 and a minutes wheel may allow for selection of a quantity of minutes by enabling a wheel to scroll through quantities of minutes in the selection box 238.

When an absence type 230 is selected at 230A that corresponds to full hour absence bookings, a drop-down menu may be displayed at selection menu 237 allowing for a selection of a whole number of hours. For example, when “sickness:hours” is selected at 230A, a selection menu 237 is displayed including a drop-down menu to select a quantity of hours. In some implementations, the employee may enter a quantity of hours from a keyboard or may select a quantity of hours via a selection wheel to select the quantity of hours. One of the quantities of time in the list may include the maximum number of hours available. For example, if the employee has 3 hours and 20 minutes available of sick time, the drop-down list may include 1, 2, 3 hours, and 3.33 hours.

When an absence type 230 is selected at 230A that corresponds to full day bookings, a drop-down menu may be displayed at selection menu 237 allowing for a selection of a quantity of whole days. For example, when “sickness:days” is selected at 230A, a selection menu 237 is displayed including a drop-down menu to select a quantity of days. In some implementations, the employee may enter a quantity of days from a keyboard or may select a quantity of days via a selection wheel to select the quantity of days. An employee with a quantity of hours that is less than a full work day may have zero days available. An employee with 15 hours available and an 8 hour work day may have one day available, and if the employee has 25 hours available the employee may have three days available, and so on. In some implementations, when an employee has 15 hours of sick time available, a drop-down list may include 1, 2, and 2.125 days for an employee with 8 hour work days.

In some implementations, an employee may select a start date for their absence at 232 and an end date at 234. The employee may enter a comment at 240. An employee may change the hours fractions format to a different format enabled by the employer. For example, when an employer enables sick time in decimal hours format, and hours and minutes format at 218, an employee may switch between them. For example, an employee may select “sickness:hrs&min” and enter 7 hours and 20 minutes. Before submitting the request, the employee may change to “sickness:dec.hrs.” As a result, the display at 237 may change from “7:20” (hours:minutes) to “7.333” (hours). The user may also make changes between any other formats allowed by the employer.

In some implementations, an absence of 7 hours and 30 minutes may be stored in a database at core business logic and persistency 170 as a decimal representation of hours for example 7.5 hours. When the transformation from hours and minutes to decimal hours results in a non-terminating decimal or has greater than a predetermined number of decimal places, the decimal value may be rounded up to a decimal value with the predetermined number of decimal places. For example, when the predetermined number of decimal places is ten, 7 hours and 20 minutes may be stored in the persistency at 170 as 7.3333333333, and 7 hours and 40 minutes may be stored as 7.6666666667.

When absence management module 140 receives a request for absence time, the associated employee may need to have the available balance in an absence time account, for example sick leave. Time account balances may be stored in decimal format, but depending on the decimal value, the decimal value may not correspond to an exact quantity of whole hours and whole minutes. For example, some employers may generate daily accruals of time account balances for their employees. For example, an employee that works 40 hours per week, 48 weeks per year (240 days per year) may accrue 0.33 hours of sick leave per day worked. In this example, each day worked may add 0.33 hours to the employee's sick leave accrual. A quantity of 0.33 hours corresponds to 19 minutes and 48 seconds. When 19 minutes and 48 seconds is rounded up to the nearest minute, the rounded quantity becomes 20 minutes. If an employee attempted to request the rounded absence time of 20 minutes, an error would occur because the decimal hours stored in the persistency 170 is only 0.33 hours, not 0.3333333333 hours. To prevent the error, the hours quantity of hours in decimal format transformed to hours and minutes format may be rounded down to the nearest minute. Continuing the above example, in some implementations the available time to the employee would be displayed as 19 minutes instead of 20 minutes.

In some implementations, the hours in a full working day may be defined in a decimal hours format. For example, an employee's work day may be 7.67 hours. Converted to an hours and minutes format, 7.67 hours may be 7 hours, 40 minutes and 12 seconds. If the employee selected “vacation:hrs&min” (vacation in hours and minutes) at 230A, and selects “7:40” (7 hours and 40 minutes) at 237, a full day's number of hours is not met because 12 seconds are missing. If the employee selects to take 7 hours and 41 minutes, an error may occur because a work day is 7 hours, 40 minutes, and 12 seconds (7.67 hours). In some implementations, the requested quantity of hours may be adjusted so that a full day is reached. For example, a request for 7 hours and 40 minutes may be saved in the database or persistency 170 as 7.67 hours to schedule a full day's work time with no remainder. In some implementations, when the requested quantity of hours is equal to a full day plus/minus half a minute, the absence request is saved as the full day quantity of hours. When the employee requests an absence in an hours and minutes format on a day with 7.67 working hours, the user interface box 237 may display 7 hours and 40 minutes according to the above-noted rounding down. When the employee books an absence for 7 hours and 40 minutes (a full day) the absence request may be rounded up to 7.67 hours from the 10 decimal place value 7.6666666667 to adjust the quantity of hours to a full day.

Although the above-noted hours may be adjusted to a quantity of hours corresponding to a full day, other target quantities may be used as well. For example, a request for a quantity of absence hours may be adjusted to quantities other than a full day such as a half day, or adjusted to equal a full quantity of hours that is available. For example, an employee with 3.67 hours of vacation may work a 4 hours and take 3 hours and 20 minutes of vacation. When the 3 hours and 20 minutes is saved, the quantity of hours requested may be adjusted from 3.6666666667 to 3.67 hours thereby zeroing out the employee's vacation time.

After selecting a type of absence and quantity of time, the absence request form 200B may be submitted by selecting or clicking on “submit” button 242 or other selection method. In some implementations, when the request is submitted, the request is then validated (validated may also be referred to as simulated). Validation may include checking for errors in the time quantity and dates. For example, validation may include checking the employee's accrued time to verify the request is less than or equal to the accrued time. Validation may include checking to verify that the requested absence day(s) between the start date and end date are one or more working days for the employee and not a scheduled day off or holiday. Validation may include checking to verify that the requested absence time makes sense. For example, if an absence request for 1 hour had an end date 3 days later than the start date, the request would be erroneous because which day the hour of absence is being requested for would be unclear. Validation may include checking to verify that the requested hours on the requested date does not exceed the employee's scheduled working hours for that date. Validation may include checking to verify that one or more limits are satisfied. For example, an employer may limit the number of absences per period of time, e.g., number of absences per month, quarter, year or other period. An employer may limit the number of hours taken per type of time account. For example, an employer may limit a minimum number of hours in a type of request such as a minimum of 2 hours in a sick time request, or 4 hours for a vacation request. Any other type minimum or maximum limit may be placed by an employer on a group of employees or an individual employee.

When the hours fractions in the selected absence type 230A is decimal hours, hours, or days, a drop-down menu may be used instead of the user entry at box 237 in FIG. 2B or the above-noted wheel entry. The drop-down menu may provide for selection of a quantity of hours in fixed increments or patterned increments. For example, a drop-down menu for an employee with 27.23 hours of available sick time when hours are the permitted fraction (e.g., sickness:hours) may display a selectable list such as 1, 2, 3, 4, . . . , 26, 27, and 27.23. The employee may then select a quantity of hours for the request from the list. The maximum value shown may be the full balance in the employee's sick time account which in this example is 27.23 hours. The list may be a patterned list such as 1, 2, 4, 8, 16, 24, and 27.3 hours. Any other pattern may be used as well. Continuing the above example, when the employee has 27.23 hours of sick leave and the permitted fraction is days, the displayed list in the drop-down may be 1, 2, 3, and 3.40 days. In some implementations, fractional days and/or hours may not be permitted. When fractional hours are not permitted the drop-down menu for 27.23 hours of accrued sick leave may be 1, 2, 3, 4, . . . , 26, and 27 hours or 1, 2, 4, 8, 16, 24, and 27 hours, or 1, 23, and 3 days (when the employee's work day is 8 hours).

In some implementations, API controller 150 or UI controller 160 may generate one or more of the views depicted in FIGS. 2A and 2B. For example, UI controller 160 may generate the graphical view and user interface shown in FIG. 2B. UI controller 160 may generate the graphical views by sending graphical instructions to web user interface 120. FIG. 2B may be the result of the instructions received at 120. When a selection is made at a drop-down menu such as 230A, 232, or 234, or when a selection is made at 236, 238, 240, 242, or 244, a message may be sent from web user interface 120 to UI controller 160 containing information indicating the selection. The selection may be made by clicking, touching, entering a keyboard character or other action. In some implementations, web user interface 120 may generate the graphical views shown in FIGS. 2A and/or 2B. Web user interface 120 may generate the graphical views and may send/receive or exchange data values used in the graphical views with UI controller 160. Instead of, or in addition to UI controller 160, API controller 150 may perform above noted operations of UI controller 160. Instead of, or in addition to web user interface 120, mobile device 110 may perform above noted operations of web user interface 120.

The screenshots in FIGS. 2A and 2B are example screenshots that may be displayed on a handheld mobile device with a small screen, on a larger mobile device, or on a desktop computer. A user interface for a larger screen may include added menus, features, or dropdown menus with a larger number of selectable options.

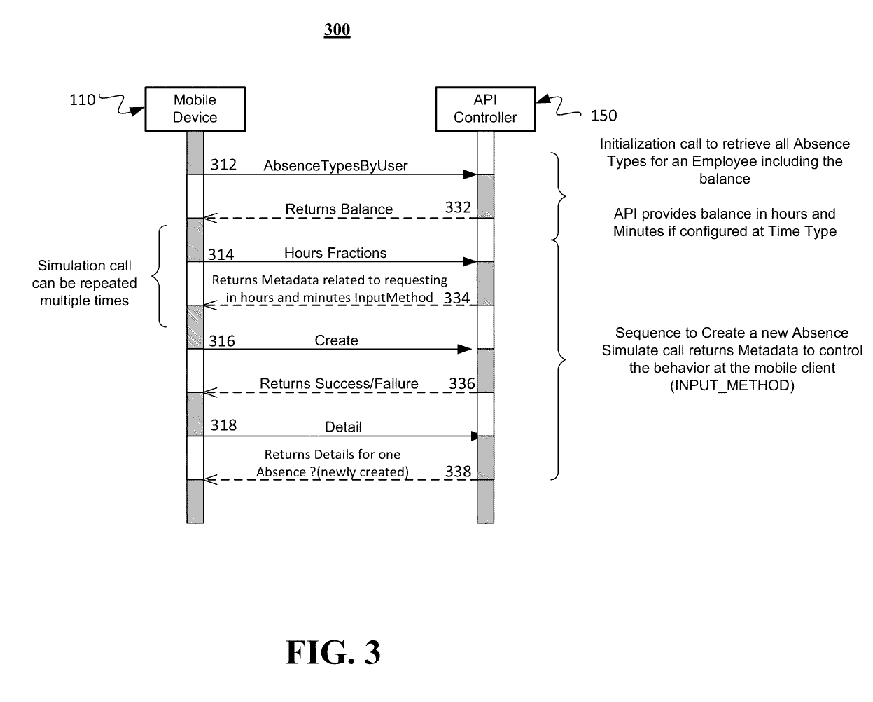

FIG. 3 depicts a message exchange diagram between a mobile device and an application controller to create a new absence for an employee, in accordance with some implementations. Mobile device 110 may initiate a series of messages to create a new absence. At 312, upon initiation of a new absence request by the user, the mobile device may send a list of absence types and a request for balances from the controller. At 332, the controller may send a message containing the time account balances for the list of absence types to the mobile device. At 314, the mobile device may request metadata to cause the mobile device to display hours and minutes. At 334, the controller may send metadata to cause the mobile device to display an absence request in an hours and minutes format. At 316, the user may request an absence in one of the hours fractions formats enabled by the employer. At 336, the controller may validate the requested absence and return a message indicating success or failure. At 318, the user at the mobile device may request details of the absence from the controller. At 338, the controller may return the details of the absence request to the mobile device. FIG. 3 also refers to FIGS. 1, 2A, and 2B.

At 312, upon initiation of a new absence request at mobile device 110, mobile device 110 may send a list of absence types and request the time balances for the absence types from the application programming interface (API) controller 150. In some implementations, mobile device may request the absence types from API controller 150 in addition to requesting the balances of the absence types.

At 332, the controller may send a message containing the time account balances for the list of absence types. For example, API controller 150 may reply with the balances in one or more formats including days, hours, and/or minutes. For example, mobile device 110 may request a balance for sick leave. API controller 150 may respond with equivalent times in one or more formats. For example, the response may include 9.0 days, 77.0 hours, and 4620 minutes (all equivalent amounts of time in different formats).

At 314, the mobile device may request metadata to cause the mobile device to display an absence request in hours and minutes. For example, mobile device 110 may send a request to API controller 150 for metadata to cause mobile device 110 to display a sick leave request in an hours and minutes format. At 334, the controller may send metadata to cause the mobile device to display an absence request in an hours and minutes format. In some implementations, 314 and 334 may be bypassed or performed by a user interface application at the mobile device 110.

At 316, the user may request to create an absence in one of the hours fractions formats enabled by the employer. For example, if the employer has enabled “sickness:hrs&min” as detailed above, and the user has selected or entered a quantity of hours and minutes at box 237, the request may be submitted a request to create the absence by activating submit button 242.

At 336, the controller may validate the requested absence and return a message indicating success or failure. Validating the request is detailed in the foregoing explanation of FIG. 1 which may include: checking for errors in the time quantity and dates, checking to verify that the requested absence day(s) between the start date and end date is a working day for the employee and not a scheduled day off or holiday, checking to verify that the requested absence time makes sense, checking to verify that the requested hours on the requested date do not exceed the employee's scheduled working hours for that date, and checking to verify that one or more limits are satisfied. Other validation checks may also be performed.

When the absence request is validated, an absence identifier may be generated. For example, an alphanumeric absence identifier may include 32 alphanumeric characters. Any other number of characters may be used. Any other type of identifier may also be used. In some implementations, a validated absence request for one or more absence types may require employer approval of the request. In some implementations, some of the requests may be approved automatically according to rules defined by the employer and implemented at the absence management module 140 or other module in backend server 130.

At 318, the user at the mobile device may request the complete details of the absence request from the controller. At 338, the controller may return the details of the absence request to the user at the mobile device 110. The absence details may include a start date, an end date, an absence type, an hours fractions type, a comment from the requestor, an employee identifier, and/or an approval status. The details may include a quantity of time requested in one or more formats including decimal days, decimal hours, and decimal minutes. Other details may also be included.

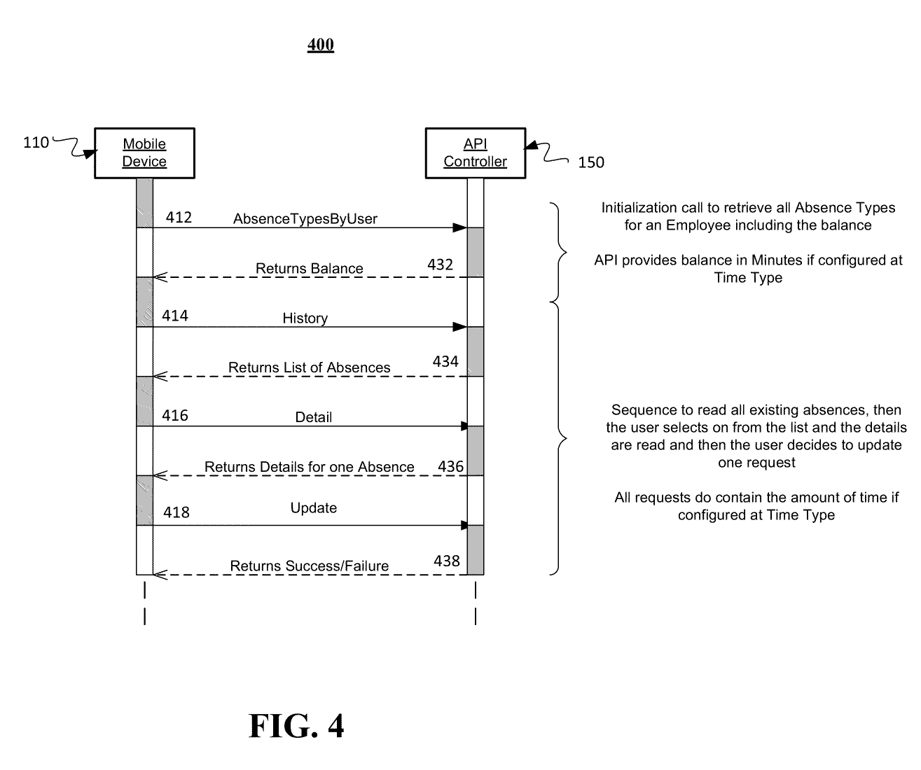

FIG. 4 depicts a message exchange diagram between a mobile device and an application controller to modify an absence for an employee, in accordance with some implementations. A user at a mobile device may initiate a series of messages to modify or update an absence. At 412, upon initiation by the user to request an update to an absence, the mobile device may send a list of absence types, and request time account balances for the absence types from the controller. At 432, the controller may send a message containing the time account balances for the list of absence types. At 414, the mobile device may request a history of absences. At 434, the controller may send a list of absences to the mobile device. At 416, the mobile device may request from the controller details of an absence selected to be updated by the user at the mobile device. At 436, the controller may send to the mobile device the details for the requested absence. At 418, the mobile device may request that the selected absence be updated based on changes made to the absence by the user. At 338, the controller may send a message to the mobile device indicating that the update was successful or that the update failed. FIG. 4 also refers to FIGS. 1, 2A, 2B, and 3.

At 412, upon requesting an update to an absence, the mobile device 110 may send a list of absence types to the application programming interface (API) controller 150, and request from API controller 150 time balances for the absence types. In some implementations, mobile device 110 may also request the absence types from the API controller 150.

At 432, the API controller 150 may send a message containing the balances of the time accounts in the list of absence types. For example, API controller 150 may reply with the balances in one or more formats including days, hours, and/or minutes. For example, mobile device 110 may request a balance for vacation. API controller 150 may respond with equivalent times in one or more formats. For example, the response may include 9.0 days, 77.0 hours, and 4620 minutes (all equivalent amounts of time in different formats).

At 414, user 105 at mobile device 110 may request a history of absences from the API controller 150. At 434, the API controller may return to mobile device 110 the history of user 105's absences. For example, an employee/user may have taken sick leave Feb. 27, 2014, for 4 hours, have a vacation absence scheduled for Dec. 29, 2014, for 6 hours, and a vacation absence scheduled for Jan. 28, 2015, for 8 hours. These absences may have been created and approved (if required by the employer) and stored in persistency 170.

At 416, the mobile device 110 may request from the API controller 150 details of an absence selected at the mobile device 110 to be updated. At 436, the controller 150 may return the details of the selected absence to be updated to the user at the mobile device 110. The absence details may include a start date, an end date, an absence type, an hours fraction type, a comment from the requestor, an employee identifier, an approval status. The details may include a quantity of time scheduled and/or approved in one or more formats including decimal days, decimal hours, and decimal minutes, and/or other details. For example, the details of the absence selected to be updated (before being updating) may be displayed to the user in the format of the screenshot of FIG. 2B. In some implementations, the user may update the absence request by editing the displayed request by using the drop-down menus to change the selections in accordance with the drop-down menu selection and time entry described in FIGS. 1 and 2B.

At 418, the mobile device may request to the API controller 150 that the selected absence be updated. In some implementations, activating a request such as submit button 242 may cause the update request to be sent to the API controller 150. Continuing the above example, the employee/user may request to update the request for vacation on Jan. 28, 2015, for 8 hours to 6 hours by adjusting the request displayed in a window consistent with FIG. 2B. The requested time may be adjusted by selecting 6 hours in the drop-down menu instead of 8 hours. In some implementations, the scheduled absence before the request is updated may be highlighted to aid the user in seeing the original request.

At 438, the controller may send a message to the mobile device indicating that the update was successful or that the request failed. In some implementations, the update request may fail if the updated request does not satisfy the validation checks described in FIGS. 1 and 2B.

In some implementations consistent with FIGS. 3 and 4, the mobile device 110 in the foregoing message exchange between mobile device 110 and API controller 150 may be replaced by web based user interface 120, and the API controller 150 may be replaced by user interface controller 160. The foregoing messages then being between web based user interface 120 and user interface controller 160.

FIG. 5 depicts a computing apparatus 500, in accordance with some implementations. An apparatus consistent with FIG. 5 may implement mobile device 110, web user interface 120, backend server 130, API controller 150, and/or UI controller 160. Computing apparatus 500 may perform the processes 300 and/or 400.

Computing apparatus 500 may include one or more processors such as processor 530 to execute instructions that may implement operations consistent with FIGS. 1-4. Apparatus 500 may include memory 510 to store executable instructions and/or information such as absence information from a database. Apparatus 500 may include a display 520 to present graphical views or screens such as the screens shown in FIGS. 2A and 2B. Apparatus 500 may include a network interface 540 to a wired network or a wireless network. Wireless networks may include WiFi, WiMax, and cellular networks (2G/3G/4G/5G), and/or any other wireless network. Apparatus 500 may user interface 550 such as a keyboard, mouse, or other interface that may include a touchscreen integrated with display 520.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other implementations may be within the scope of the following claims.

What is claimed:

1. A method comprising:
receiving, by a remote node, an absence type and a balance of time for the absence type, wherein the balance of time is expressed in a first format including at least one of a days format, an hours format, or a minutes format;
selecting, at a user interface of the remote node, a display format for the balance of time;
receiving, by the remote node, metadata enabling a presentation of the balance of time in the selected display format;
converting, by the remote node, the balance of time to the selected display format;
receiving, at the user interface of the remote node, a request for an absence corresponding to the absence type including an absence duration formatted in accordance with the selected display format;
converting, by the remote node, the absence duration into the at least one format to provide comparability between selected display format and the first format;
sending, by the remote node, the request for the absence including the absence type and converted absence duration;
receiving a response to the request, wherein the response includes an indication of whether the request for the absence is granted, wherein the indication is determined at least by a validation that the balance of time is equal to or greater than the absence duration.

2. The method of claim 1, wherein the balance of time comprises the minutes format and the display format comprises the hours and minutes format, wherein the minutes format includes a decimal quantity of minutes, and wherein the hours and minutes format includes a decimal quantity of hours and a decimal quantity of minutes less than sixty.

3. The method of claim 1, wherein an amount of time in the hours format is equivalent to the amount of time in the days format, wherein the amount of time in the minutes format has an equivalent number of whole minutes and a decimal fraction of a minute.

4. The method of claim 3, wherein the decimal fraction of the minute is stored in a second format to provide accrual of time in the absence type, and wherein the first format includes the minutes format, wherein the decimal fraction of the minute is truncated or rounded down.

5. The method of claim 1, wherein the remote node is one or more of a smartphone, a cell phone, a laptop computer, a tablet computer, a notebook computer, or a netbook.

6. The method of claim 1, wherein the absence type includes one or more of a vacation time, a sick time, a maternity leave, an educational leave, a personal time off, a paid leave, an unpaid leave, a marriage leave, or a bereavement leave.

7. The method of claim 1, wherein the hours format includes whole hours and one to ten decimal places, the days format includes whole days and one to ten decimal places, and the minutes format includes whole minutes and one to ten decimal places.

8. The method of claim 1, wherein the request is sent to an enterprise resource planning system, which sends the response.

9. A non-transitory computer readable medium containing executable instructions, that when executed by at least one processor perform operations comprising:
receiving, by a remote node, an absence type and a balance of time for the absence type, wherein the balance of time is expressed in a first format including at least one of a days format, an hours format, or a minutes format;
selecting, at a user interface of the remote node, a display format for the balance of time;
receiving, by the remote node, metadata enabling a presentation of the balance of time in the selected display format;
converting, by the remote node, the balance of time to the selected display format;
receiving, at the user interface of the remote node, a request for an absence corresponding to the absence type including an absence duration formatted in accordance with the selected display format;
converting, by the remote node, the absence duration into the at least one format to provide comparability between selected display format and the first format;
sending, by the remote node, the request for the absence including the absence type and converted absence duration;
receiving a response to the request, wherein the response includes an indication of whether the request for the absence is granted, wherein the indication is determined at least by a validation that the balance of time is equal to or greater than the absence duration.

10. The non-transitory computer readable medium of claim 9, wherein the balance of time comprises the minutes format and the display format comprises the hours and minutes format, wherein the minutes format includes a decimal quantity of minutes, and wherein the hours and minutes format includes a decimal quantity of hours and a decimal quantity of minutes less than sixty.

11. The non-transitory computer readable medium of claim 9, wherein an amount of time in the hours format is equivalent to the amount of time in the days format, wherein the amount of time in the minutes format has an equivalent number of whole minutes and a decimal fraction of a minute.

12. The non-transitory computer readable medium of claim 11, wherein the decimal fraction of the minute is stored in a second format to provide accrual of time in the absence type, and wherein the first format includes the minutes format, wherein the decimal fraction of the minute is truncated or rounded down.

13. The non-transitory computer readable medium of claim 9, wherein the remote node is one or more of a smartphone, a cell phone, a laptop computer, a tablet computer, a notebook computer, or a netbook.

14. The non-transitory computer readable medium of claim 9, wherein the absence type includes one or more of a vacation time, a sick time, a maternity leave, an educational leave, a personal time off, a paid leave, an unpaid leave, a marriage leave, or a bereavement leave.

15. The non-transitory computer readable medium of claim 9, wherein the hours format includes whole hours and one to ten decimal places, the days format includes whole days and one to ten decimal places, and the minutes format includes whole minutes and one to ten decimal places.

16. The non-transitory computer readable medium of claim 9, wherein the request is sent to an enterprise resource planning system, which sends the response.

17. A system compromising:
at least one processor; and
at least one memory including instructions that when executed by the at least one processor provide operations comprising:
receiving, by a remote node, an absence type and a balance of time for the absence type, wherein the balance of time is expressed in a first format including at least one of a days format, an hours format, or a minutes format;
selecting, at a user interface of the remote node, a display format for the balance of time;
receiving, by the remote node, metadata enabling a presentation of the balance of time in the selected display format;
converting, by the remote node, the balance of time to the selected display format;
receiving, at the user interface of the remote node, a request for an absence corresponding to the absence type including an absence duration formatted in accordance with the selected display format;
converting, by the remote node, the absence duration into the at least one format to provide comparability between selected display format and the first format;
sending, by the remote node, the request for the absence including the absence type and converted absence duration;
receiving a response to the request, wherein the response includes an indication of whether the request for the absence is granted, wherein the indication is determined at least by a validation that the balance of time is equal to or greater than the absence duration.

18. The system of claim 17, wherein the balance of time comprises the minutes format and the display format comprises the hours and minutes format, wherein the minutes format includes a decimal quantity of minutes, and wherein the hours and minutes format includes a decimal quantity of hours and a decimal quantity of minutes less than sixty.

19. The system of claim 17, wherein an amount of time in the hours format is equivalent to the amount of time in the days format, wherein the amount of time in the minutes format has an equivalent number of whole minutes and a decimal fraction of a minute.

20. The system of claim 19, wherein the decimal fraction of the minute is stored in a second format to provide accrual of time in the absence type, and wherein the first format includes the minutes format, wherein the decimal fraction of the minute is truncated or rounded down.
